(19) United States
(12) Patent Application Publication
(10) Pub. No.: US 2020/0063690 A1
(43) Pub. Date: Feb. 27, 2020

(54) POLYMERIC AND METAL CYLINDER HEAD AND METHOD OF MAKING THE SAME

(71) Applicant: GM GLOBAL TECHNOLOGY OPERATIONS LLC, Detroit, MI (US)

(72) Inventors: Anthony M. COPPOLA, Rochester Hills, MI (US); Peter P. ANDRUSKIEWICZ, IV, Ann Arbor, MI (US); Hamid G. KIA, Bloomfield Hills, MI (US); Paul M. NAJT, Bloomfield Hills, MI (US)

(73) Assignee: GM GLOBAL TECHNOLOGY OPERATIONS LLC, Detroit, MI (US)

(21) Appl. No.: 16/108,449

(22) Filed: Aug. 22, 2018

(51) Int. Cl. F02F 7/00; F02F 1/36; F02F 1/16; F02F 1/00; B29C 70/70; B29C 70/68; B29C 70/48; B29C 70/22

(52) U.S. Cl. CPC F02F 7/0087; F02F 7/007; F02F 1/36; F02F 1/16; F02F 1/004; F05C 2253/16; B29C 70/682; B29C 70/48; B29C 70/222; F05C 2225/08; F05C 2251/048; B29C 70/70

(57) ABSTRACT

A cylinder head assembly for an engine assembly is provided herein. The cylinder head assembly may include a head framework, an exhaust liner include a thermal barrier material, an intake liner, and a polymeric housing disposed around at least a portion of the metal head framework and the exhaust liner. The cylinder head assembly may further include a plurality of channels for heating and/or cooling the cylinder head assembly, which can be defined in one or more of: the metal head framework, the exhaust liner, and the polymeric housing. Methods of making the cylinder head assembly are also provided herein.

The present disclosure relates generally to a cylinder head assembly and a method of making the same, and more specifically, to a cylinder head assembly including a metal head framework, a polymeric housing, and channels defined in the cylinder head assembly, which are capable of receiving a fluid for cooling at least a portion of the cylinder head assembly.

Traditionally, engine components for automotive applications have been made of metals, such as steel and iron. Metal components are robust and typically have good ductility, durability, strength and impact resistance. While metals have performed as acceptable engine components, they have a distinct disadvantage in being heavy and reducing gravimetric efficiency, performance and power of a vehicle thereby reducing fuel economy of the vehicle.

Weight reduction for increased fuel economy in vehicles has spurred the use of various lightweight metal components, such as aluminum and magnesium alloys as well as use of lightweight polymeric materials. While use of such lightweight materials can serve to reduce overall weight and generally may improve fuel efficiency, issues can arise when using such materials in an engine assembly due to high operating temperatures associated with the engine assembly. The lightweight metal components can have relatively high linear coefficients of thermal expansion, as compared to traditional steel or ceramic materials. In engine assemblies, the use of such lightweight metals can cause uneven thermal expansion under certain thermal operating conditions relative to adjacent components having lower linear coefficients of thermal expansion, like steel or ceramic materials, resulting in separation of components and decreased performance. Additionally, lightweight polymeric materials may have strength limitations, such as diminished tensile strength, and they can degrade after continuous exposure to high temperatures. Thus, lightweight engine assemblies having increased durability under high temperature operating conditions are needed to further improve efficiency of operation and fuel economy.

### SUMMARY

This section provides a general summary of the disclosure, and is not a comprehensive disclosure of its full scope or all of its features.

In certain aspects, the present disclosure provides a cylinder head for an engine including a metal head framework, an exhaust liner defining an exhaust port, an intake liner defining an intake port, a polymeric housing disposed around at least a portion of the metal head framework and the exhaust liner, and plurality of channels. The metal head framework may define portion of: a combustion chamber, an intake valve guide, and an exhaust valve guide. The exhaust liner can include a thermal barrier material including an insulating layer, and the intake liner can include a material selected from the group consisting of a metal material, a polymeric material, the thermal barrier material, or combinations thereof. The exhaust liner can be disposed adjacent to at least a portion of the metal head framework. The plurality of channel may be defined in one or more of: (i) the metal head framework; (ii) the exhaust liner; and (iii) the polymeric housing.

The polymer in the polymeric housing and the polymeric material each can include a thermoplastic polymer or a thermoset polymer.

The polymeric housing and the polymeric material each can further include a plurality of reinforcing fibers, wherein the plurality of reinforcing fibers are selected from the group consisting of carbon fibers, glass fibers, aramid fibers, polyethylene fibers, organic fibers, metallic fibers, and a combination thereof.

The plurality of channels each has a diameter of about 100 μm to about 10 mm.

The plurality of channels may include an outer shell having a wall thickness of about 1 μm to about 1 mm, wherein the outer shell includes a metal, a polymer, a polymeric composite, or a combination thereof.

The plurality of channels defined in the metal head framework, the exhaust liner, and the polymeric housing may be interconnected with one another.

At least a portion of the plurality of channels can extend circumferentially around a first exterior surface of the exhaust liner or at least a portion of the plurality of channels can extend longitudinally along the first exterior surface of the exhaust liner.

The insulating layer further may include a plurality of microspheres including at least one of a metal alloy, polymer, glass, and ceramic, wherein the plurality of microspheres each has a diameter of about 10 μm to 100 μm. Further, the insulating layer can have a porosity of at least about 50%.

The thermal barrier material may further include a sealing material.

In other aspects, the present disclosure provides a method of manufacturing a cylinder head assembly for an engine. The method includes (a) a thermal barrier formation step, (b) a casting step, (c) a channel formation step for forming an intermediate assembly, and (d) a polymeric formation step. The thermal barrier formation step can include one or more of the following: (i) applying an insulating layer precursor to a second exterior surface of an exhaust port form and solidifying the insulating layer precursor applied to the second exterior surface of the exhaust port form to form an exhaust liner comprising a thermal barrier material; and (ii) applying the insulating layer precursor to a third exterior surface of an intake port form and solidifying the insulating layer precursor applied to the third exterior surface of the intake port form to form an intake liner comprising the thermal barrier material; and (iii) performing a casting, molding, or three-dimensional (3D) printing process to form the exhaust liner defining an exhaust port and/or the intake liner defining an intake port and providing a packing material to the exhaust port and/or the intake port. The casting step can include one or more of the following: (i) arranging the exhaust liner in a first mold and casting a metal head framework defining a portion of a combustion chamber; and (ii) arranging the intake liner in the first mold and casting the metal head framework. The channel formation step for forming the intermediate assembly can include applying a channel precursor material including a sacrificial material to the exhaust liner, the metal head framework, or a combination thereof. The polymeric formation step can include placing the intermediate assembly in a second mold, introducing a polymer precursor into the second mold, solidifying the polymer precursor to form a solid polymeric assembly including a polymeric housing, and if present, removing the sacrificial material to form a plurality of channels. The polymeric housing may be disposed around one or more of: at least a portion of the metal head framework, at least a portion of the exhaust liner; and at least a portion of the intake liner. The plurality of channels may be defined in one or more of: (i) the metal head framework; (ii) the polymeric housing; and (iii) the exhaust liner.

The polymer can include a thermoplastic polymer or a thermoset polymer.

Applying the channel precursor material may include one or more of: (i) applying the channel precursor material circumferentially around at least a portion of a first exterior surface of the exhaust liner; (ii) applying the channel precursor material within a void region between microspheres in the exhaust liner; and (iii) applying the channel precursor material longitudinally along at least a portion of the first exterior surface of the exhaust liner.

The sacrificial material may include a material capable of one or more of: melting, vaporizing, combusting, and solubilizing.

The channel precursor material may further include an outer shell containing the sacrificial material, wherein outer shell includes a metal, a polymer, a polymeric composite, a ceramic, or a combination thereof. The sacrificial material may include a material capable of one or more of: melting, vaporizing, combusting, and solubilizing, and the shell can remain after the sacrificial material is removed.

The insulating layer can include a low conductivity material and/or the insulating layer further can include a plurality of microspheres including at least one of a metal alloy, polymer, glass and ceramic. The thermal barrier formation step may further include one or more of: (i) adhering the respective plurality of microspheres applied to the second exterior surface of the exhaust port form together to form the exhaust liner and (ii) adhering the respective plurality of microspheres applied to the third exterior surface of the intake port form together to form the intake liner.

The thermal barrier formation step can further include one or more of: (i) applying a sealing material to the second exterior surface of the exhaust port form; (ii) applying the sealing material to the third exterior surface of the intake port form; (iii) applying the sealing material to a fourth exterior surface of the insulating layer precursor; and (iv) applying the sealing material to a fifth exterior surface of the thermal barrier material.

The casting step can further include arranging an intake liner port form in the first mold and the metal head framework further defines a portion of an intake liner.

The polymeric housing can further defines a portion of an intake liner.

The insulating layer may have a porosity of at least about 50% and the plurality of microspheres each may have a diameter of about 10 μm to 100 μm.

The plurality of channels defined in the metal head framework, the exhaust liner, and the polymeric housing may be interconnected with one another.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a cross-sectional view of a cylinder head assembly according to one aspect of the disclosure.

FIG. 1B is an exploded view of a thermal barrier material comprising an insulating layer in the cylinder head assembly of FIG. 1A, illustrating details of the thermal barrier material.

FIG. 1C is an exploded view of another aspect of the thermal barrier material in the cylinder head assembly of FIG. 1A, illustrating details of the thermal barrier material.

FIG. 2A is a cross-sectional view of a microsphere according to one aspect of the disclosure.

FIG. 2B is a cross-sectional view of a microsphere according to another aspect of the disclosure.

FIG. 2C is a cross-sectional view of a microsphere according to another aspect of the disclosure.

FIG. 3A is a cross-sectional view of a cylinder head assembly according to another aspect of the disclosure.

FIG. 3B is a cross-sectional view of a cylinder head assembly according to another aspect of the disclosure.

FIG. 3C is a cross-sectional view of a cylinder head assembly according to another aspect of the disclosure.

FIG. 4A is a cross-section view of an exhaust liner according to one aspect of the disclosure.

FIG. 4B is a cross-section view of an exhaust liner according to another aspect of the disclosure.

FIG. 4C is a cross-section view of an exhaust liner according to another aspect of the disclosure.

FIG. 5A is a cross-sectional view of a cylinder head assembly illustrating flow of a heat transfer fluid through a plurality of channels according to one aspect of the disclosure.

FIG. 5B is a cross-sectional view of another cylinder head assembly illustrating flow of a heat transfer fluid through a plurality of channels according to another aspect of the disclosure.

FIG. 5C is a cross-sectional view of another cylinder head assembly illustrating flow of a heat transfer fluid through a plurality of channels according to another aspect of the disclosure.

FIG. 6 is a cross-sectional view of a channel according to one aspect of the disclosure.

FIGS. 7A-7E illustrate a thermal barrier formation step according to one aspect of the disclosure. FIG. 7A is a cross-sectional view of an exhaust port form and an intake port form illustrating application of an insulating layer precursor according to one aspect of the disclosure. FIG. 7B is a cross-sectional view of an exhaust port form and an intake port form illustrating application of an insulating layer precursor comprising a plurality of microspheres. FIG. 7C is an exploded view of the insulating layer precursor in FIG. 7B, illustrating details of the insulating layer precursor. FIG. 7D is a cross-sectional view of the formed exhaust liner and intake liner. FIG. 7E is a cross-sectional view of an exhaust port form and an intake port form illustrating application of a sealing layer and an insulating layer precursor according to another aspect of the disclosure.

FIG. 8 illustrates a casting step showing formation of head framework according to one aspect of the disclosure.

FIG. 9 illustrates a channel formation step showing application of a channel precursor material to an exhaust liner according to one aspect of the disclosure.

FIG. 10 illustrates a polymeric formation step showing formation of a polymeric housing according to one aspect of the disclosure.

FIG. 11 illustrates a removal step showing formation of plurality of channels according to one aspect of the disclosure.

FIG. 12A is a cross-sectional view of a sacrificial material according to one aspect of the disclosure.

FIG. 12B is a cross-sectional view of a sacrificial material according to another aspect of the disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In a vehicle, such as an automobile, an engine is a power source that produces torque for propulsion. The engine is an assembly of parts, including cylinder liners, pistons, crankshafts, combustion chambers, and the like. In a four stroke internal combustion engine each piston has an intake stroke, a compression stroke, a power stroke, and an exhaust stroke. During the intake stroke, a piston moves downward and an inlet valve is opened to permit a gaseous air mixture to fill a combustion chamber. During the compression stroke, intake and exhaust valves are closed and the piston moves upward to compress the gaseous air mixture. During the power stroke, the gaseous air mixture in the combustion chamber is ignited by a spark plug and the rapidly expanding combustion gases drive the piston downward. During the exhaust stroke, the exhaust valve is opened and the piston moves upward to discharge the combustion gases (exhaust gases). Overall, during internal combustion, the engine components may be subjected to varying amounts of stresses as well as varying temperatures due to the exothermic combustion reactions occurring in the engine block.

As discussed above, as weight of engine components increases, power, fuel economy, and efficiency may decrease. Thus, it is desirable to include various lightweight components, such as lightweight metals and lightweight polymeric materials, in engine assemblies instead of the traditional steel and/or iron components to decrease weight of the engine but also to maintain structural integrity of the engine.

Thus, engine assemblies for use in vehicle assemblies are provided herein which include a combination of components formed of lightweight materials (e.g., polymeric materials) and traditional materials. Advantageously, such engine assemblies also may result in an improvement in noise, vibration and harshness. While the engine assemblies described herein are particularly suitable for use in components of an automobile, they may also be used in a variety of other vehicles. Non-limiting examples of vehicles that can be manufactured by the current technology include automobiles, tractors, buses, motorcycles, boats, mobile homes, campers, aircrafts (manned and unmanned), and tanks.

### I. Cylinder Head Assemblies

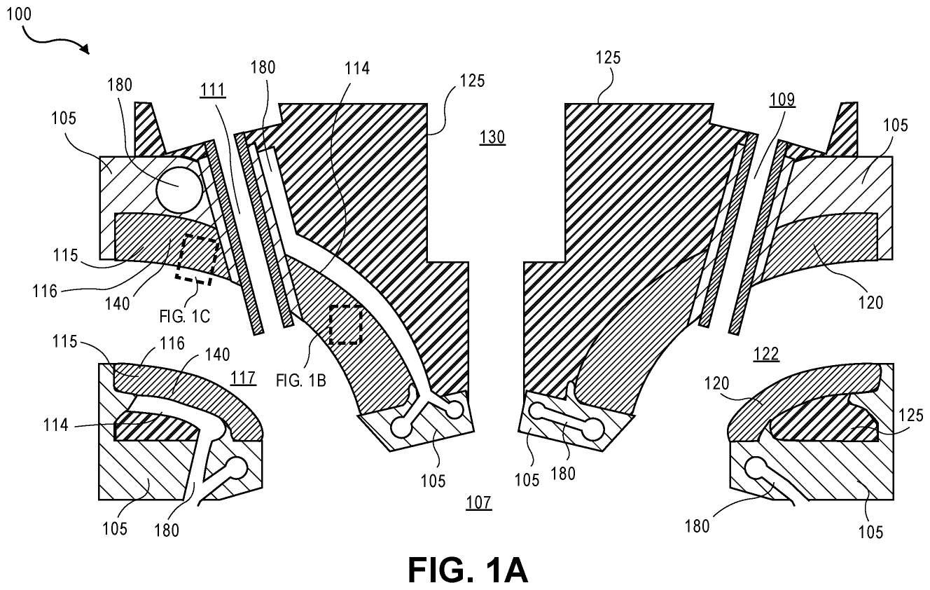

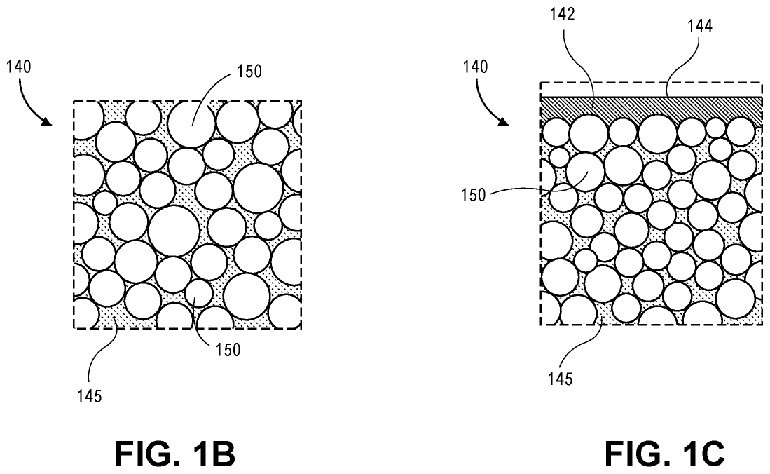

In particular, an engine assembly, such as a cylinder head assembly including a head framework, an exhaust liner, an intake liner, a polymeric housing, and a plurality of channels defined in the cylinder head assembly is provided herein. For example, as best shown in FIG. 1A, an exemplary cylinder head assembly 100 is provided. The cylinder head assembly 100 includes components generally associated with a cylinder head and an upper portion of an internal combustion engine. The cylinder head assembly 100 includes a head framework 105, an exhaust liner 115, an intake liner 120, and a polymer housing 125. The head framework 105 is a skeletal structure that defines and/or forms various aspects of the cylinder head assembly 100. For example, the head framework 105 can define a portion of one or more of: a combustion chamber 107, an intake valve guide 109, and an exhaust valve guide 111. The cylinder head assembly 100 may further include a combustion device (not shown). The combustion device may include, but is not limited to a fuel injector, a spark plug, a glow plug, or some other device that supports combustion.

The head framework 105 may be any suitable material, such as but not limited to a metallic material (e.g., iron, magnesium alloy, aluminum alloy, steel alloy, metal composite, and combinations thereof), a ceramic material (e.g., alumina, silicon carbide, ceramic composite), and combinations thereof. In any embodiment, the head framework 105 may include a metal material. While the description of the cylinder head assembly 100 refers to and describes only single components, for example, a single combustion chamber 107, single exhaust liner 115, single intake liner 120, etc., it is contemplated herein that the cylinder head assembly 100 may include any number of components described herein, e.g., combustion chambers, exhaust liners, intake liners, etc. For example, the cylinder head assembly 100 may include two, three, four, or five combustions chambers, exhaust liners, intake liners, etc.

The intake liner 120 can define an intake port 122, which provides a fluid passage for supplying a flow of combustion air to the combustion chamber 107. The exhaust liner 115 can define an exhaust port 117, which provides a fluid passage for discharging a flow of exhaust gas from the combustion chamber 107. The intake valve guide 109 can slideably support an intake valve (not shown) as understood by those in the art. The intake valve is operable to open and close fluid communication through the intake port 122. The exhaust valve guide 111 can slideably support an exhaust valve (not shown) as understood by those in the art. The exhaust valve is operable to open and close fluid communication through the exhaust port 117.

In any embodiment, the exhaust liner 115 can comprise a thermal barrier material 140 which is capable of controlling and limiting heat transfer from the exhaust gas to the solid components of the cylinder head assembly 100. In various aspects, the thermal barrier material 140 can form an insulator configured to reduce heat transfer losses, increase efficiency, and increase exhaust gas temperature during operation of the cylinder head assembly 100 in an engine. With reference to FIG. 1A, the thermal barrier material 140 may be disposed on a face or surface of one or more of the components the cylinder head assembly 100, including, but not limited to, the head framework 105, the exhaust valve guide 111, the polymeric housing 125 and the like.

The thermal barrier material 140 can be configured to provide low thermal conductivity to thermally protect the polymeric housing 125 and to increase engine efficiency. As such, the low thermal conductivity reduces heat transfer losses through thermal barrier material 140, minimizing cooling requirements and maintaining a portion of the thermal barrier material 140 adjacent to the polymeric housing 125 at a desirable lower temperature. Additionally, the exhaust gas leaving the combustion chamber can retain more heat that could be used to increase engine efficiency, and the intake gas could remain cooler to improve the engine's volumetric efficiency. In one non-limiting embodiment, the thermal barrier material 140 may be about 500 microns (μm) in thickness and exhibit a calculated thermal conductivity of about 0.7 W/mK and a porosity of about 50%.

Referring now to FIG. 1B, the thermal barrier material 140 may include an insulating layer 145 (also referred to herein as “insulating layer material 145”). The insulating layer 145 may be comprised of one or more layers. In any embodiment, the insulating layer 145 can comprise any suitable low conductivity material, for example, a ceramic material, such as oxide ceramics (e.g., aluminum titanate) and/or a lower conductivity metal alloy (e.g., a Ni—Cr alloy, such as Inconel), preferably with hollow voids or chambers, which can be formed by machining or three-dimensional (3D) printing. Additionally or alternatively, the insulating layer 145 may include a plurality of microspheres 150 (also referred to herein as “microspheres 150”), preferably hollow microspheres 150. In any embodiment, the microspheres 150 may be adhered together to create a layer having higher porosity and mostly closed celled structure. For example, adhered microspheres 150 may be sintered together, adhered together via the insulating layer 145, adhered together with an additional adherent agent, or any combinations thereof. In other words the insulating layer 145 may be configured as a matrix material to bond with the plurality of microspheres 150. It is contemplated here in that insulating layer 145 may be present surrounding substantially the entirety of the microspheres 150 and/or there may be voids present between the microspheres 150 wherein substantially no insulating layer 145 may be present. Additionally or alternatively, the insulating layer 145 may comprise other suitable sealed porous structures, such as, but not limited to hollow chambers or voids, pockets, closed-cell metallic, and/or ceramic foams, etc. In any embodiment, where porosity is intended in the insulating layer 145, the porosity of the insulating layer 145 may be at least about 50%, at least about 60%, at least about 70%, at least about 80%, at least about 90%, at least about 95%; or from about 50% to about 95%, about 60% to about 95% or about 70% to about 90%. A higher porosity of the insulating layer 145 can provide for a corresponding volume of air and/or gases to be contained therein, thus providing the desired insulating property of low effective thermal conductivity.

In any embodiment, the thickness of the insulating layer 145 may be between about 0.5 mm μm and 5 mm. Additionally or alternatively, the insulating layer 145 may be configured to withstand pressures of around 5 bar and withstand surface temperatures of around 1,100° C.

The microspheres 150 may be comprised of at least one of: a polymeric, metal (including metal alloys), glass, and ceramic material. In any embodiment, the microspheres 150 are comprised of metal, such as nickel (Ni), nickel alloy compounds, iron-chromium-aluminum (FeCrAl) alloys, cobalt (Co) alloys, and the like for durability and resistance to oxidation and corrosion at high temperatures, e.g., around 1,000° C. The microspheres 150 may each have a diameter of less than or equal to about 1 mm, for example, between about 10 μm and about 100 μm or between about 30 μm and about 50 μm. The wall thickness of the microspheres 150 may be between about 0.5 μm and 5 μm. It is contemplated herein that the insulating layer 145 may comprise microspheres 150 each having a substantially uniform diameter or the insulating layer 145 may comprise microspheres 150 having varying diameters.

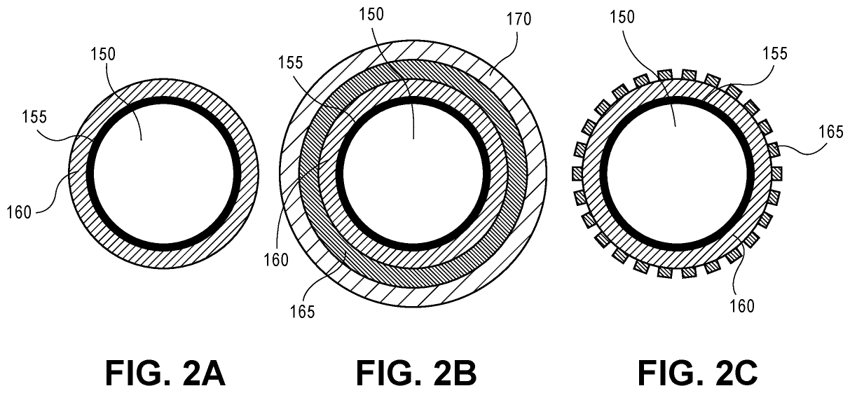

Referring now to FIG. 2A-2C, microspheres 150 are illustrated that may be formed by a variety of processes. A microsphere 150 may be formed with a base surface 155. The base surface 155 may be formed of a material to limit conductivity and heat capacity as part of the completed microsphere 150, for example, the base surface may be formed of a polymeric material, ceramic material, metal material, and/or glass material to provide a spherical shaped template for the microsphere 150. The base surface 155 may be formed using a variety of materials, including, but not limited to, polyvinylidene chloride copolymer for a hollow microsphere 150 or a polystyrene for a solid microsphere 150 that may be removed at a later step in the formation process. Alternatively, hollow spheres formed using ceramics such as glass bubbles or cenospheres such as fillite, can also be used but may not be removed in the formation process.

In any embodiment, a first coating 160 may be applied to at least a portion of the base surface 155. The first coating 160 may comprise a metal material, such as nickel that is applied or deposited over substantially the entire base surface 155 via electroless plating or a chemical vapor deposition (CVD) process. It is also appreciated that another material, such as iron or cobalt could be used as the first coating 160 material in place of nickel.

The thickness of the first coating 160 may be tailored by adjusting the amount of time of the plating process at a specified temperature, for example between about 0.2 μm and about 2 μm of nickel may be deposited depending on the diameter of the base surface 155 and the target density of the insulating layer 145.

A second coating 165 may then be applied and/or deposited over at least a portion of the first coating 160, as depicted in FIG. 2B. The second coating 165 may be a material that forms an alloy with the first coating 160. In one embodiment the first coating 160 contains nickel and the second coating contains at least one or more elements, including, but not limited to, zinc (Zn), copper (Cu), chromium (Cr), aluminum (Al), cobalt (Co), molybdenum (Mo), tungsten (W), tantalum (Ta), titanium (Ti), zirconium (Zr), hafnium (Hf) and/or yttrium (Y). It can be advantageous for the second coating 165 to form an alloy with the first coating 160, as pure nickel can provide limited strength and oxidation and corrosion resistance at elevated temperatures. The alloying material of the second coating 165 may be applied to at least a portion of the first coating 160 by an electroless plating, CVD, vapor phase deposition process or dry sputtering.

It is understood herein that the materials used with the base surface 155 of microsphere 150, the first coating 160, and the second coating 165 may be adjusted without affecting the functionality of the microsphere 150. In any embodiment, the second coating 165 may be chromium that is about 5% to about 30% of the thickness of the first coating 160. In another embodiment, the second coating 165 may be aluminum that is about 5% to about 30% of the thickness of the first coating 160.

In any embodiment, microsphere 150 can includes a base surface 155 including polymeric, glass or ceramic material at least partially covered by a first coating 160 that comprises mostly nickel or cobalt or iron and is deposited by electroless plating or CVD. The second coating 165 can comprise a first alloying element, such as chromium or aluminum, which at least partially covers the first coating 160. A third coating 170 of a second alloying element can at least partially cover the second coating 165. In any embodiment, the coating thicknesses can be configured to yield the ratio of elements of the target alloy. For example, the ratio of elements may be a nickel alloy with about 22% by weight of chromium and about 10% by weight of aluminum to produce hollow microspheres 150 with a 50 μm diameter and 1 μm shell thickness. In such an embodiment, a first coating 160 of about 0.53 μm of nickel can be deposited on the base surface 155, followed by a second coating 165 of about 21 μm chromium, and then a third coating 170 of about 26 μm aluminum. After application of the first coating 160, second coating 165, and third coating 170, microspheres 150 may be subjected to a homogenization heat treatment of about 1200° C. for 48 hours to interdiffuse the elements in the three coatings and form a homogeneous alloy. An optional ageing heat treatment of about 900° C. for 8 hours or a similar time and temperature may be performed to form precipitates that strengthen the nickel alloy.

In another embodiment the outer coating, either the first coating 160, second coating 165, or third coating 170 depending on how many coatings are deposited, is selected from a group of materials including zinc (Zn), copper (Cu), silver (Ag) and aluminum (Al) that exhibit a lower melting point than the first coating and therefore promote sintering of the microspheres to each other and to the substrate and optionally, a sealing material (as further discussed below).

Alternatively, as is shown in FIG. 2C, the second coating 165 may include nanoparticles containing alloying elements with diameters of about 20 nm to about 500 nm, which may be applied to the first coating 160. The nanoparticles, which may contain Inconel® alloys, nickel base superalloys or stainless steel, and may be diffused into the first coating 160 using heat treatments of between about 1000° C. and about 1100° C. for a period of about 10 hours to about 20 hours. The first coating 160 may comprise mostly nickel, cobalt or iron deposited by electroless plating of CVD. The heat treatments may be performed after a thermal barrier material 140 coating has been applied to a substrate, but they could also be performed before application to the substrate. In any embodiment, the second coating 165 of nanoparticles may be comprised of Inconel® alloy or nickel based superalloy particles having a diameter of about 20 nm to about 200 nm with the coating being about 5% to about 30% of the thickness of the first coating 160.

Additionally or alternatively, with references to FIGS. 1A and 1C, the thermal barrier material 140 may optionally further include a sealing material 142 disposed over a portion of the insulating layer 145 and/or a portion of the microspheres 150. In any embodiment, the sealing material 142 may be present on a portion of a first outer surface 116 of the exhaust liner 115. Thus, in any embodiment, the sealing material 142 may be disposed between the insulating layer 145 and the exhaust port 117. Additionally or alternatively, the sealing material 142 may be present on a portion of a first exterior surface 114 of the exhaust liner 115 such that the sealing material 142 may be disposed between the insulating layer 145 and channels 180 (further described below). Although not shown, it is also contemplated herein that the sealing material 142 may be present on an insulating layer 145, which does not include microspheres 150. The sealing material 142 may be a high temperature thin film. More specifically, the sealing material 142 may comprise a material that can be configured to withstand temperatures of at least 1100° C. The sealing material 142 may be configured to be a thickness of about 1 μm to about 20 μm.

The sealing material 142 may be non-permeable to combustion gases, such that a seal is provided between the sealing material 142 and the insulating layer 145. Such a seal can prevent debris from combustion gases, such as unburned hydrocarbons, soot, partially reacted fuel, liquid fuel, and the like, from entering the porous structure defined by the hollow microspheres 150. If such debris were allowed to enter the porous structure of the insulating layer 145, air disposed in the porous structure may end up being displaced by the debris, and the insulating properties of the insulating layer 140 may be reduced or eliminated.

The sealing material 142 may be configured to present an outer surface 144 that is substantially smooth. Having a smooth sealing material 142 can prevent the creation of turbulent airflow as the exhaust gas flows across the outer surface 144 of the sealing material 142. Further, having a sealing material 142 with a smooth surface can prevent an increased heat transfer coefficient. In one non-limiting example, the sealing material 142 may be applied to the insulating layer 145 via electroplating, vacuum deposit and spraying. In another non-limiting example, the sealing material 142 may be a thin film comprised of metals including nickel, nickel alloy, cobalt alloy, iron alloy or steel that is applied to the insulating layer 145 simultaneously with or after sintering the insulating layer 145.

The sealing material 142 may be configured to be sufficiently resilient so as to resist fracturing or cracking during exposure to debris. Further, the sealing material 142 may be configured to be sufficiently resilient so as to withstand any expansion and/or contraction of the underlying insulating layer 145. Further, the insulating layer 145 and sealing material 142 can each be configured to have compatible coefficient of thermal expansion characteristics to withstand thermal fatigue. The sealing material 142 may have a thickness between about 5 μm and about 200 μm or greater than 200 μm.

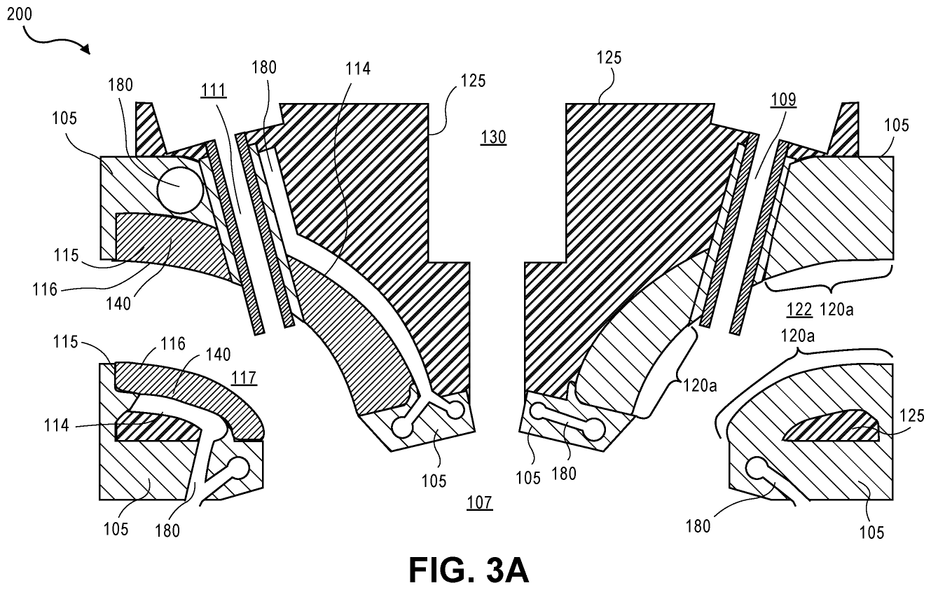

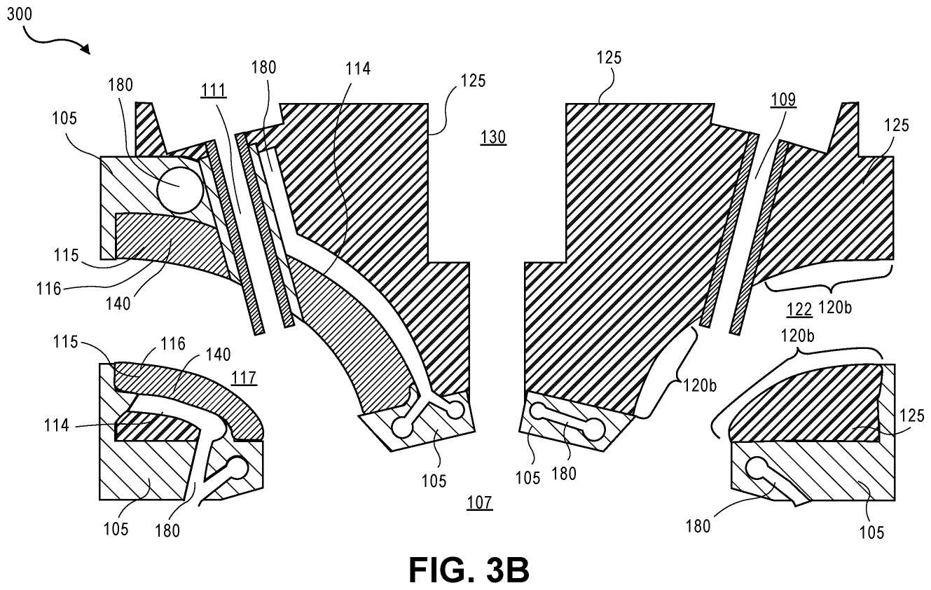

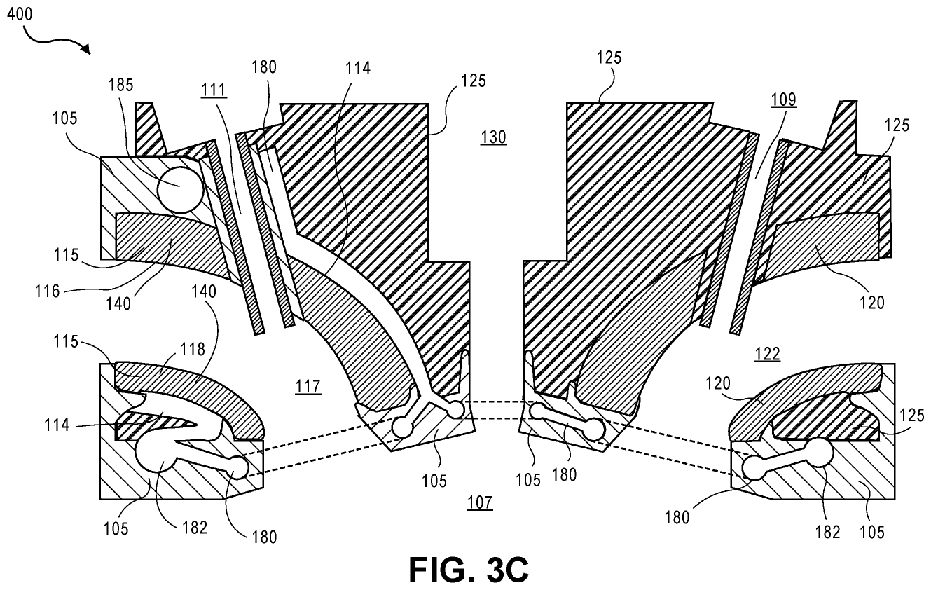

Although not shown, it is contemplated herein that the intake liner may comprise the thermal barrier material 140 as described herein, optionally further comprising the microspheres 150 as described herein and/or the sealing material 142 as described herein. In any embodiment, the thermal barrier material of the intake liner may be the same or different thermal barrier material of the exhaust liner. Alternatively, the intake liner 120 may comprise a polymeric material, a metal material, a ceramic material, or a combination thereof. It is also contemplated herein that the exhaust liner 115 alternatively can comprise a metal material, a ceramic material, or a combination thereof. For example, as depicted in FIG. 3A in cylinder head assembly 200, an intake liner 120a may be defined by the head framework 105 and/or integral with the head framework 105. Alternatively, as depicted in FIG. 3B in cylinder head assembly 300, an intake liner 120b may be defined by the polymer housing 125 and/or integral with the polymeric housing 125. In a further alternative embodiment, as depicted in FIG. 3C in cylinder head assembly 400, the polymer housing 125 can replace a portion of the head framework 105 as shown in FIG. 1.

Additionally, the cylinder head assembly 100 may further include a polymeric housing 125 disposed around at least a portion of one or more of: the head framework 105, the exhaust liner 115, and the intake liner 120. The polymeric housing may define a combustion device region 130 for housing a combustion device as described herein. In any embodiment, the polymeric housing 125 may comprise any suitable polymer and optionally, a plurality of suitable reinforcing fibers. Examples of suitable polymers include, but are not limited to a thermoset polymer (e.g., thermoset resin), a thermoplastic polymer (e.g., thermoplastic resin), elastomer and combination thereof. Preferable polymers include, but are not limited to epoxies, phenolics, vinylesters, bismaleimides, polyether ether ketone (PEEK), polyamides, polyimides and polyamideimides. Examples of suitable reinforcing fibers include, but are not limited to carbon fibers, glass fibers, aramid fibers, polyethylene fibers, organic fibers, metallic fibers, ceramic fibers, basalt fibers, quartz fibers, graphite fibers, nanofibers, boron fibers, and combinations thereof. In particular, the reinforcing fibers are glass fibers, carbon fibers, and/or carbon fiber straps. The reinforcing fibers may be continuous fibers and/or discontinuous fibers. In particular, the reinforcing fibers are discontinuous fibers. Advantageously, the polymeric housing 125 as described herein may have a compression strength of about 100 MPa to about 2000 MPa, about 500 MPa to about 1000 MPa or about 1000 MPa to about 1500 MPa.

Additionally, the cylinder head assembly 100 includes a plurality of channels 180 (also referred to herein as “channels 180”) for receiving a fluid, such as a heat transfer fluid, for heating and/or cooling the cylinder head assembly 100. Examples of suitable heat transfer fluids include, but are not limited to, air, water, oil, ethylene glycol, propylene glycol, glycerol, methanol, and combinations thereof. The air may be supplied from an air conditioning system or produced from movement of the vehicle. The heat transfer fluid may be at supplied at a suitable temperature to cool and/or heat the cylinder head assembly 100, e.g., about −40° C. to about 120° C., about −40° C. to about 20° C., about 10° C. to about 120° C., about 20° C. to about 100° C. or about 20° C. to about 90° C. Advantageously, the channels 180 can efficiently remove heat produced in the cylinder head assembly 100, particularly, heat produced in the combustion chamber 107 and as it flows through the exhaust port 115 and contacts the exhaust liner 115.

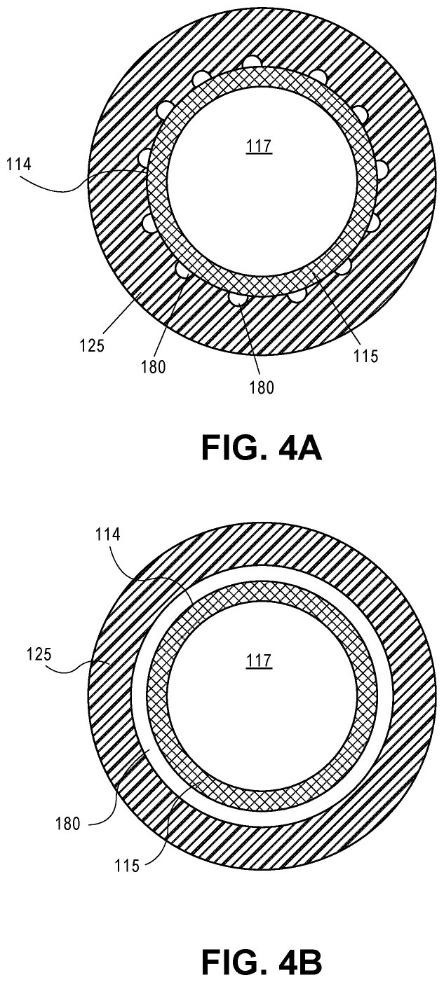

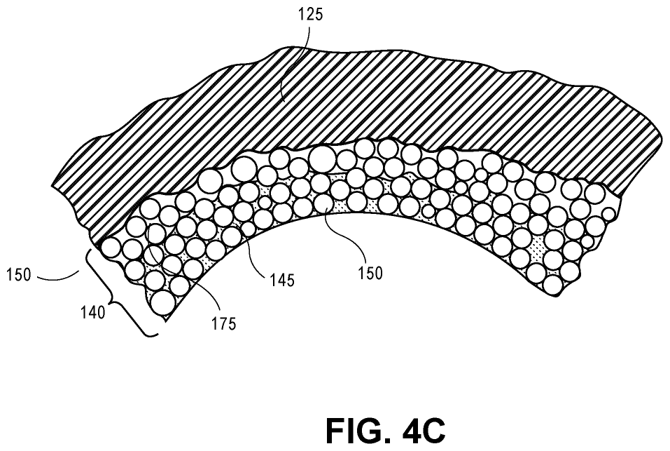

As illustrated in FIG. 1, the plurality of channels 180 may be defined in one or more of: the head framework 105, the exhaust liner 115, and the polymeric housing 125. Although not shown, it is contemplated herein that the channels 180 may also be defined in the intake liner 120. The plurality of channels 180 are illustrated in FIG. 1 (and in later figures) as a solid portion for clarity purposes. However, it is appreciated that the plurality of channels 180 can be a plurality of separate channels (see FIG. 4A). In any embodiment, the channels 180 defined in one or more of: the head framework 105, the exhaust liner 115, the intake liner 120, and the polymeric housing 125 may be interconnected with one another including fluidly interconnected and/or physically interconnected.

In various aspects, the channels 180 may be oriented in any suitable configuration in the head framework 105, the exhaust liner 115, the intake liner 120, and/or the polymeric housing 125, for example, circumferentially, radially, longitudinally, branched, intersecting, criss-crossing and combinations thereof. For example, as shown in FIG. 4A, the channels 180 may extend longitudinally along a first exterior surface 114 of the exhaust liner 115. Although not shown, the channels 180 may optionally extend longitudinally along an exterior surface of the intake liner 120. As used herein, “longitudinally along” is intended to encompass configurations where the channels 180 extend longitudinally along the first exterior surface 114 of the exhaust liner 115 and/or longitudinally within an interior region of the exhaust liner 115, for example, wherein the channels 180 are defined by and/or interwoven within and present within any void spaces between microspheres 150 in the exhaust liner 115. For example, as depicted in FIG. 4C, a heat transfer fluid may flow through voids 175 (or interstitial spaces 175) defined between microspheres 150, for example, where the insulating layer 145 is not present.

Additionally or alternatively, as shown in FIG. 4B, the channels 180 may extend circumferentially around the first exterior surface 114 of the exhaust liner 115. Although not shown, the channels 180 may optionally extend circumferentially around an exterior surface of the intake liner 120. As used herein, “circumferentially around” is intended to encompass configurations where the channels 180 extend circumferentially around the first exterior surface 114 of the exhaust liner 115 and/or within an interior region of the exhaust liner 115, for example, wherein the channels 180 are interwoven within and present within any void spaces between microspheres 150 in the exhaust liner 115. 0.

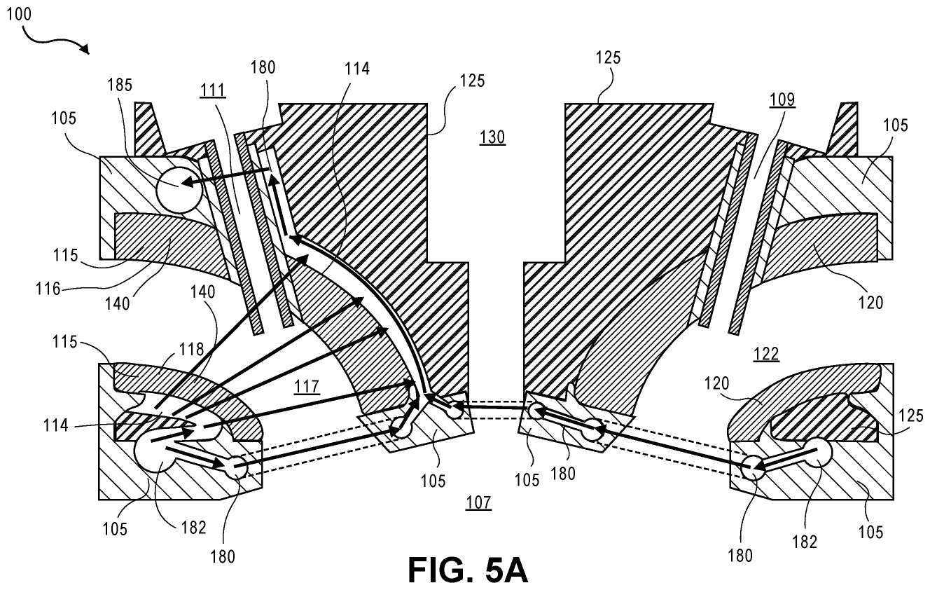

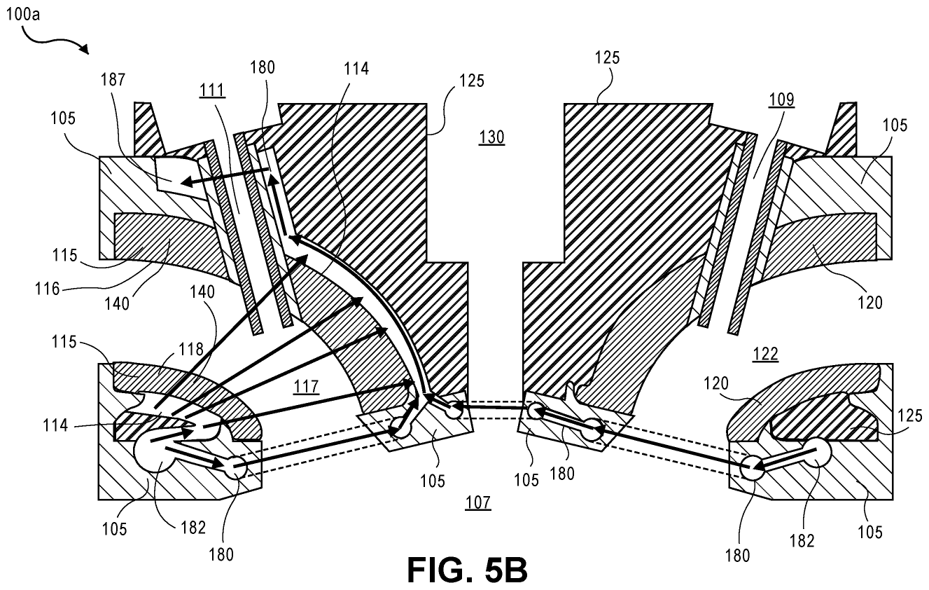

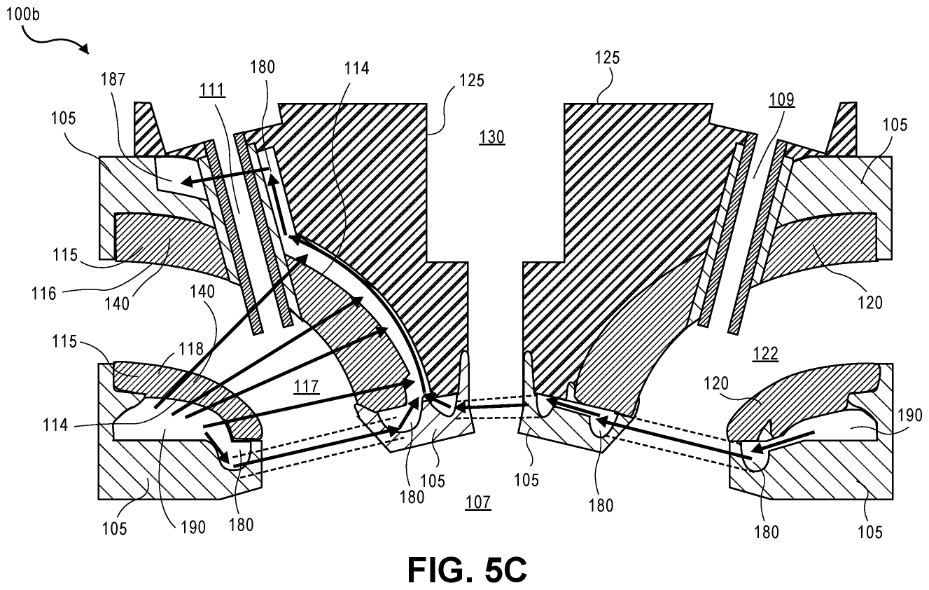

Cylinder head assemblies as described herein may include one or more inlets for receiving a heat transfer fluid and one or more outlets for removal of spent heat transfer fluid in any suitable configuration. For example, as depicted in FIG. 5A, the cylinder head assembly 100 may comprise one or more first inlets 182 defined in a portion of the head framework 105 and polymeric housing 125 for receiving a heat transfer fluid, and one or more first outlets 185 defined in a portion of the head framework 105 for removal of the spent heat transfer fluid. The first inlet(s) 182 may comprise one or more channels 180, and the first outlet(s) 185 may comprise one or more channels 180. Alternatively, as depicted in FIG. 5B, a cylinder head assembly 100a may comprise one or more first inlets 182 defined in a portion of the head framework 105 and polymeric housing 125 for receiving a heat transfer fluid, and one or more second outlets 187 defined in a portion of the head framework 105 and the polymer housing 125 for removal of the spent heat transfer fluid. The first inlet(s) 182 may comprise one or more channels 180, and the second outlet(s) 187 may comprise one or more channels 180. Further alternative inlet and outlet configurations are depicted in FIGS. 5C and 5D. As shown in FIG. 5C, cylinder head assembly 100b includes one or more second inlets 190 and one or more second outlets 187. The arrows shown in FIGS. 5A-5C show an exemplary flow of heat transfer fluid from the inlets 182, 190 through the channels 180 and into the outlets 185, 187.

In various aspects, the heat transfer fluid may be supplied by at least one pump (not shown) from at least one supply reservoir or supply channel (not shown) to at least one inlet (e.g., first inlet 182, second inlet 190) in the cylinder head assembly (e.g., cylinder head assembly 100, cylinder head assembly 100a, cylinder head assembly 100b, cylinder head assembly 100c). The pump and supply reservoir may be present adjacent to the cylinder head assembly. Optionally, the heat transfer fluid may flow through a cooler (not shown) to further reduce the temperature of the heat transfer fluid or the heat transfer fluid may flow through a heater (not shown) to increase the temperature of the heat transfer fluid.

In any embodiment, the channels 180 each may have any suitable cross-section, for example, a substantially round cross-section, substantially rectangular cross-section or a combination thereof. As understood herein, “substantially round” may include circular and oval cross-sections and the dimensions of the cross-section may deviate in some aspects. As understood herein, “substantially rectangular” may include square cross-sections and the dimensions of the cross-section may deviate in some aspects. Each of the channels 180 may have a diameter of about 10 μm to about 25 mm, about 50 μm to about 15 mm, about 100 μm to about 10 mm, about 500 μm to about 10 mm, about 100 μm to about 10 mm, about 1 mm to about 10 mm, or about 1 mm to about 5 mm.

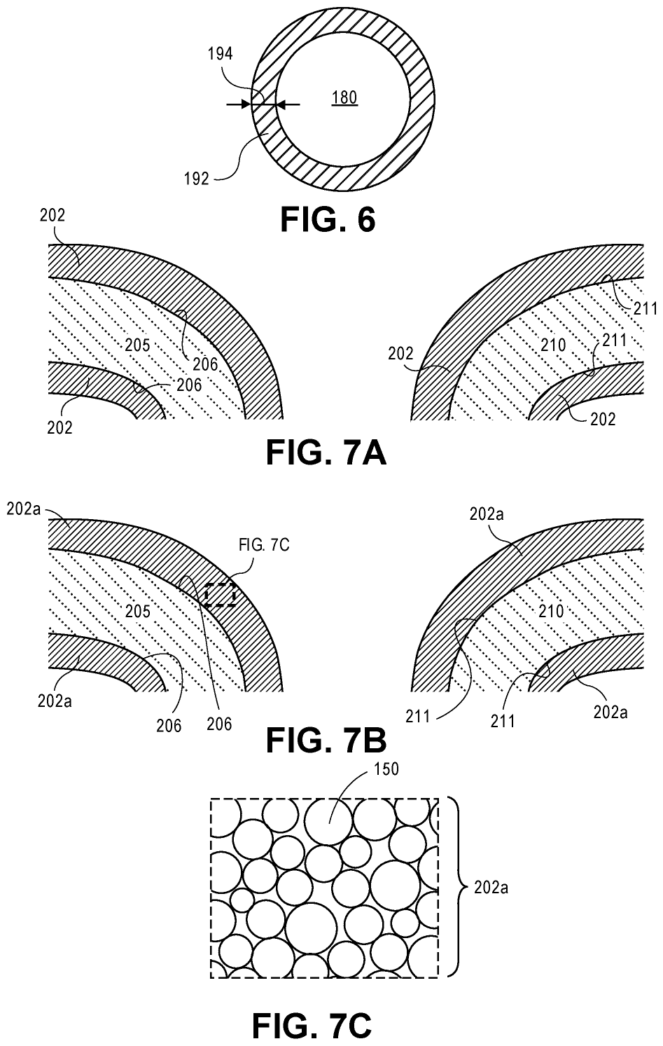

In some embodiments, as depicted in FIG. 6, which shows a cross-section of a single channel 180, a channel 180 may comprise an outer shell 192 having a wall thickness 194. The wall thickness 194 may range from about 1 μm to about 5 mm, about 1 μm to about 1 mm, about 50 μm to about 2 5 mm, about 100 μm to about 1 mm, or about 200 μm to about 800 μm. In various aspects, the outer shell 192 may comprise a metal (e.g., stainless steel, copper, aluminum), a polymer (epoxy, nylon, polyphthalamide (PPA), polyphenylene sulfide (PPS), nylon, polypropylene (PP), polyethylene (PE)), a polymeric composite, a ceramic, or a combination thereof.

### II. Methods of Making the Cylinder Head Assemblies

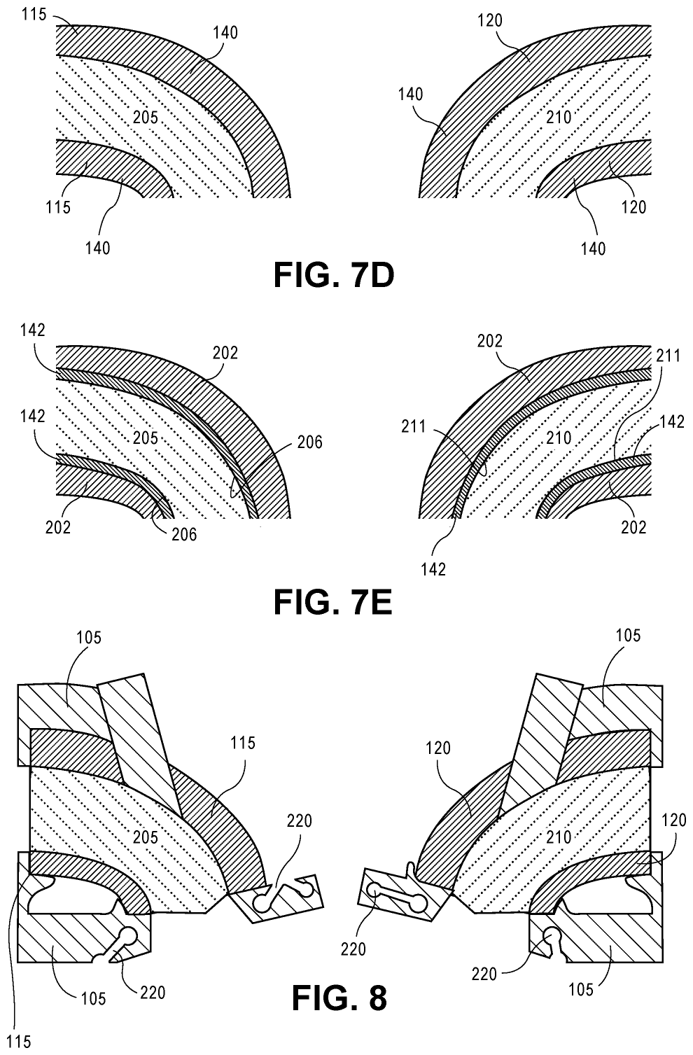

Methods of making the cylinder head assemblies described herein are also provided. The method may include one or more of: (a) a thermal barrier formation step; (b) a casting step; (c) a channel formation step; and (d) a polymeric formation step. In any embodiment, the thermal barrier formation step may comprise applying an insulating layer precursor to an exterior surface of an exhaust port form and solidifying the insulating layer precursor applied to the exterior surface of the exhaust port form to form an exhaust liner comprising a thermal barrier material as described herein. Additionally or alternatively, the thermal barrier formation step may comprise applying an insulating layer precursor to an exterior surface of an intake port form and solidifying the insulating layer precursor applied to the exterior surface of the intake port form to form an intake liner comprising a thermal barrier material as described herein. For example, as shown in FIG. 7A, an insulating layer precursor 202 may be applied to a second exterior surface 206 of an exhaust port form 205 and/or an insulating layer precursor 202 may be applied to a third exterior surface 211 of an intake port form 210. Additionally or alternatively, the thermal barrier formation step may comprise performing a casting, molding (e.g., as injection molding), or three-dimensional (3D) printing process, for example, using the insulating layer precursor 202a or any other suitable material (e.g., metal or ceramic), to form exhaust liner as described herein defining an exhaust port and/or an intake liner as described herein defining an intake port. A packing material, such as sand, can then be provided to the exhaust port to form an exhaust port form disposed within the exhaust port and/or the intake port to form an intake port form disposed within the intake port.

Additionally or alternatively, as depicted in FIGS. 7B and 7C an insulating layer precursor 202a may further comprise microspheres 150 as described herein. The insulating layer precursor 202a comprising the microspheres 150 may be applied to the second exterior surface 206 of the exhaust port form 205 and/or the insulating layer precursor 202a comprising the microspheres 150 may be applied to the third exterior surface 211 of the intake port form 210.

The insulating layer precursor (e.g., insulating layer precursor 202, insulating layer precursor 202a) may comprise any suitable low conductivity material as described herein (e.g., a ceramic material). As used herein, “insulating layer precursor” encompasses materials suitable for forming the insulating layer (e.g., the low conductivity material described above) of the thermal barrier material. For example, where an insulating layer comprising a ceramic material is to be formed, the insulating precursor may be a ceramic polymer or a pre-ceramic polymer or slurry that creates a ceramic insulating layer when baked, dried, or fired. This may include processes like slip-casting a liquid ceramic, polymer infiltration to result in a ceramic-matrix, and more conventional molding and pressurizing or firing techniques. The insulating layer precursor may be applied in slurry form or in particle form. For example, the slurry may comprise the insulating layer precursor, microspheres 150, a solvent, such as water, and a water soluble binder, for example, polyvinyl-alcohol, polyvinyl-pyrrolidone, or cellulose polymer derivatives. An organic solvent such as isopropanol or acetone can also be added to water or fully substituted for the solvent in which case the binder must be suitably soluble in the mixture, such as a polyvinyl butyral resin. Other slurry additives, for example polyethylene-glycol and glycerol, may be used for rheological adjustments such as deflocculation, lubrication, and antifoaming to maximize the packing efficiency upon slurry application. Preferably the slurry is fluidized for application by addition of just enough solvent to flow smoothly, for example about 10 milliliters (ml) for 10 grams (g) of dry microspheres 150 and a minimum amount of binder is also added to reduce residual carbon after burnout. The insulating layer 145 may be formed by applying a slurry of the microspheres 50 and the insulating layer precursor 202 to the second exterior surface 206 of the exhaust port form 205 and/or the third exterior surface 211 of the intake port form 210 by spray coating, dipping, painting, doctor-blading or other methods.

Following application of the insulating layer precursor (e.g., insulating layer precursor 202, insulating layer precursor 202a), the insulating layer precursor may be solidified to form exhaust liner 115 and/or the intake liner 120 each comprising the thermal barrier material 140 as described herein, as depicted in FIG. 7D. In any embodiments, solidification of the insulating layer precursor (e.g., insulating layer precursor 202, insulating layer precursor 202a) to form the thermal barrier material 140 may include one or more of: drying the insulating layer precursor to remove solvent and adhering together the respective microspheres 150 applied to the exhaust port form 205 and/or the intake port form 210, for example, via sintering, providing a further adherent agent to the microspheres 150, or performing firing or pyrolysis of the insulating layer precursor, for example, a pre-ceramic polymer. Sintering can be performed in an inert or reducing atmosphere. The organic components of the slurry can either be removed during a separate burn-out heat treatment in air at about 400-600° C. before sintering or during the sintering step.

In any embodiment, a sealing material 142 as described herein may be optionally applied to the second exterior surface 206 of the exhaust port form 205 and/or to the third exterior surface 211 of the intake port form 210, for example, prior to application of the insulating layer precursor (e.g., insulating layer precursor 202, insulating layer precursor 202a) as depicted in FIG. 7E. Additionally or alternatively, the sealing material 142 may be applied to a fourth exterior surface (not shown) of the insulating layer precursor (e.g., insulating layer precursor 202, insulating layer precursor 202a), for example, prior to solidification. Additionally or alternatively, the sealing material 142 may be applied to a fifth exterior surface (not shown) of the thermal barrier material 140, for example, following solidification. In any embodiment, the sealing material 142 may be applied, for example, via dip coating or via spray coating, onto one or more of: the exhaust port form 205, the intake port form 210, the insulating layer precursors 202a, and the thermal barrier material 140.

While FIGS. 7A-7E depict formation a thermal barrier material 140 with both the exhaust port form 205 and the intake port form 210, it is contemplated herein that the thermal barrier material 140 may be formed with only the exhaust port form 205 to form the exhaust liner 115.

In any embodiment, the casting step may include arranging the exhaust liner 115 and exhaust port form 205 in a first mold (not shown) and casting a head framework 105 (e.g., a metal head framework) defining a portion of the combustion chamber 107, as depicted in FIG. 8. Additionally or alternatively, the casting step may also include arranging the intake liner 120 and intake port form 205 in the first mold (not shown) and casting the head framework 105 (e.g., a metal head framework), as depicted in FIG. 8. In some embodiments, the head framework 105 (e.g., a metal head framework) may define at least a portion of the intake liner 120. Channel guides 220 for the channels 180 may also be formed in the head framework 105, for example, via drilling. In some embodiments, the channel guides 220 may serves as the channels 180.

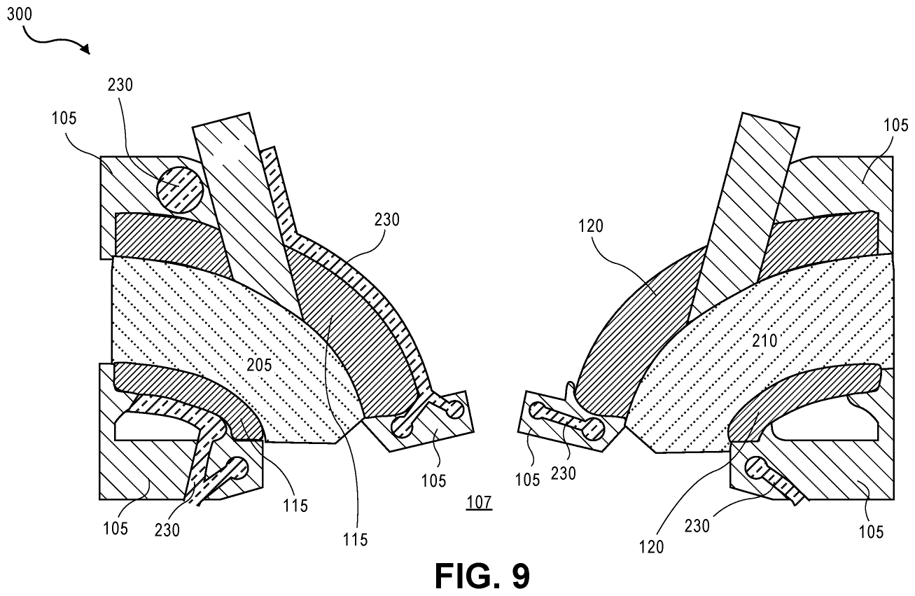

In any embodiment, the channel formation step may include applying a channel precursor material comprising a sacrificial material to the exhaust liner, head framework, or a combination thereof to form an intermediate stator assembly. An exemplary depiction of the application step is shown in FIG. 9 wherein channel precursor material 230 can be applied to or within the exhaust liner 115 and/or the head framework 105, for example, in the channel guides 220 to form intermediate assembly 300. In any embodiment, the channel precursor material 230 can be held in place adjacent to the exhaust liner 115 and/or the head framework 105 with any suitable adhesive or lacing. Although not shown, it is contemplated herein that the channel precursor material 230 can be applied to or within the intake liner 120.

In any embodiment, the application step may comprise applying the channel precursor material 230 circumferentially around at least a portion of the first exterior surface 114 of the exhaust liner 115. Additionally or alternatively, the application step may comprise applying the channel precursor material 230 within a void region (such as void regions 175 as shown in FIG. 4C) between microspheres 150, if present, in the exhaust liner 115. Additionally or alternatively, the application step may comprise applying the channel precursor material 230 longitudinally along at least a portion of the first exterior surface 114 of the exhaust liner 115.

In any embodiment, the method further includes a polymeric formation step or a potting step comprising placing the intermediate stator assembly in a second mold (not shown), introducing a polymer precursor into the mold, and solidifying (e.g., cooling, reacting, cross-linking) the polymer precursor under suitable conditions to form a solid polymeric assembly comprising a polymer. The polymer precursor may include any suitable polymer precursor or polymer for forming the polymer, for example, for forming a thermoset polymer (e.g., thermoset resin), a thermoplastic polymer (e.g., thermoplastic resin), elastomer and a combination thereof. Preferable polymers include, but are not limited to epoxies, phenolics, vinylesters, bismaleimides, polyether ether ketone (PEEK), polyamides, polyimides and polyamideimides. In some embodiments, the polymeric housing 125 may be formed by injection molding. For example, the second mold may include a housing defined void space for receiving a polymer precursor. The housing defined void space may be defined by a metal or polymer boundary present in the mold, which delineates the shape of the polymeric composite housing. The polymer precursor may be introduced into the mold followed by solidification (e.g., cooling, reacting, cross-linking) to form solid polymeric stator assembly comprising the polymeric housing 125. Alternatively, the polymeric housing 125 may be formed by other suitable techniques, such as, but not limited to, pultrusion, reaction injection molding, compression molding, prepreg molding (in autoclave or as compression molding), resin transfer molding, and vacuum assisted resin transfer molding.

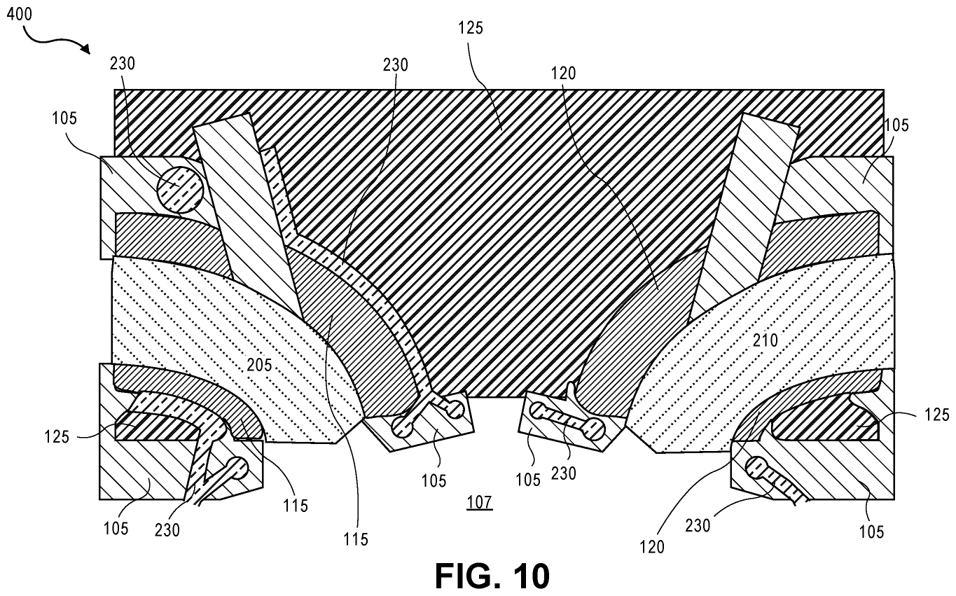

For example, as depicted in FIG. 10, a solid polymeric assembly 400 was formed during a polymeric formation step by placing intermediate assembly 300 in a second mold (not shown), introducing a polymer precursor (not shown) into the mold, and solidifying the polymer precursor to form solid polymeric assembly 400. Solid polymeric assembly 400 may include a polymeric housing 125 disposed around at least a portion of one or more of: the head framework 105, the exhaust liner 115, and the intake liner 120. In some embodiments, the polymeric housing 125 may define at least a portion of the intake liner 120 (see FIG. 3B).

In some embodiments, the method may further include, for example, during the application step or the polymeric formation step, optionally arranging a plurality of reinforcing fibers adjacent to the intermediate assembly 300. Examples of reinforcing fibers include, but are not limited to, continuous fibers and/or discontinuous fibers selected from the group consisting of carbon fibers, glass fibers, aramid fibers, polyethylene fibers, organic fibers, metallic fibers, ceramic fibers, basalt fibers, quartz fibers, graphite fibers, nanofibers, boron fibers, and a combination thereof. The reinforcing fibers may be made by any other suitable methods known in the art, e.g., braiding, weaving, stitching, knitting, prepregging, hand-layup and robotic or hand placement of tows.

In some embodiments, polymeric composites can be formed by using strips of a composite precursor material, such as the reinforcing fibers. The composite may be formed with one or more layers, where each layer can be formed from contacting and/or overlapping strips of the fiber-based material. The reinforcing fibers may also comprise a polymer precursor (e.g., a polymer). The polymer precursor can be solidified (e.g., cooled, reacted, cross-linked) and thus can serve to bond single or multiple layers together in the polymeric composite. Various methods typically can be employed for introducing polymer precursor to impregnate fiber-based substrate composite material (e.g., reinforcing fibers) systems: wet winding (or layup), pre-impregnating (referred to as “pre-preg”), and resin transfer molding. For wet winding, a dry fiber reinforcement material (e.g., reinforcing fibers) can be wetted with the polymer precursor (e.g., resin) as it is used, usually by submersion through a bath. For pre-impregnating (pre-preg), the polymer precursor is wetted into the fiber-based material in advance, and usually includes a step of partially solidifying the polymer precursor to have a viscous or tacky consistency (also known as a B-stage partial cure), and then winding up the pre-preg fiber-based material for later use. Pre-preg composite material systems tend to use thermoset resin systems, which can be solidified by elevated temperatures with solidification times ranging from about 1 minute to about 2 hours (depending solidification temperatures). However, some pre-preg materials may employ resins that solidify with actinic radiation (e.g., ultraviolet radiation (UV)). For resin transfer molding, dry fiber reinforcement material may be placed into a mold and resin may be infused into the mold under pressure (e.g., about 10 psi to about 2000 psi). Injection molding techniques known in the art may also be used to introduce polymer precursor (e.g., resin) into the reinforcement material, particularly where the reinforcement material comprise discontinuous fibers. For example, a precursor comprising a polymer precursor (e.g., resin) and the reinforcement material may be injected or infused into a defined space or mold followed by solidification of the precursor to form the polymeric composite material. The term “injection molding” also includes reaction injection molding using a thermoset polymer.

In certain other aspects, the present teachings also contemplate an attaching step where a fiber-based reinforcement material (e.g., reinforcing fibers) is applied, for example, via filament winding, braiding or weaving near, within, and/or over a work surface (e.g., intermediate assembly 300). The method may optionally comprise applying or introducing a polymer precursor (e.g., unreacted resin) composition into or onto the fiber-based reinforcement material. By applying, it is meant that the unreacted polymer precursor composition is wetted out onto the fiber-based reinforcement material and thus may be coated on a surface of the fiber-based reinforcement material or imbibed/impregnated into the fiber-based reinforcement material (for example, into the pores or openings within the reinforcing fibers). After the polymer precursor is introduced to the regions having the reinforcement material, followed by solidifying (e.g., curing or reacting) to form the polymeric composite. Pre-preg fiber-based material may be applied via filament winding, braiding or weaving as well.

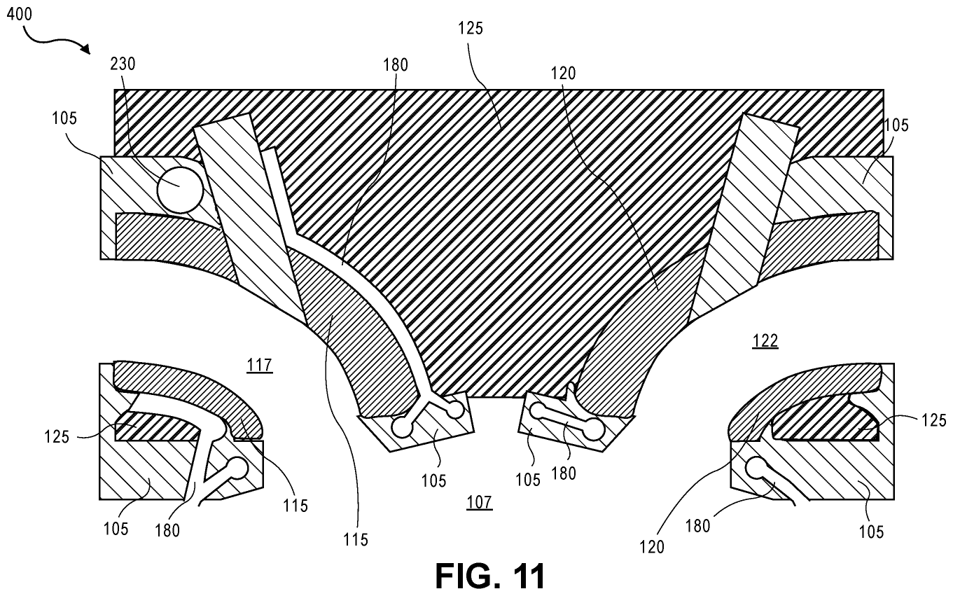

After the polymeric formation step, the solid polymeric assembly 400 may be further treated (e.g., heated) in a removal step to remove sacrificial material of the channel precursor material 230 to form a plurality of channels 180 defined in one or more of: (i) the polymeric housing 125; (ii) the exhaust liner 115; (iii) the head framework 105; and (iv) the intake liner 120. For example, FIG. 11 illustrate the channels 180 formed after the removal step.

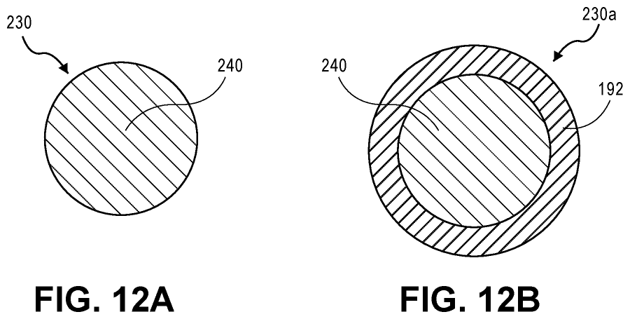

As shown in FIG. 12A, a channel precursor material 230, such as a fiber, comprise a sacrificial material 240. In some embodiments, as shown in FIG. 12B, the channel precursor material 230a may further comprise an outer shell 192 as described herein (e.g., metal, polymer, polymeric composite, ceramic or combination thereof) containing or encapsulating the sacrificial material 240. In any embodiment, the sacrificial material 240 may comprise a material capable of one or more of: melting, vaporizing, combusting, and solubilizing. Examples of suitable sacrificial material 240 includes, but is not limited to metals, polymers, combustible materials, and combinations thereof. Non-limiting metals may include solders, which comprise lead, tin, zinc, aluminum, suitable alloys and the like. Non-limiting polymers may include polyvinyl acetate, polylactic acid, polyethylene, polystyrene. Non-limiting combustible materials may include ceramics, salts (e.g., potassium nitrate), black powder, charcoal, pentaerythritol tetranitrate, combustible metals, combustible oxides, thermites, nitrocellulose, pyrocellulose, flash powders, smokeless powder, and combinations thereof. Additionally or alternatively, the sacrificial material 240 may further be treated with a catalyst or chemically modified to alter melting or degradation behavior. In some embodiments, where the channel precursor material 230a includes an outer shell 192, the sacrificial material 240 may also be a gas, such as air.

Thus, the removal step may comprise volatilizing, melting, combusting or degrading the sacrificial material 240 or the sacrificial material 240 may be dissolved to produce degradants. For example, the sacrificial material 240 may be heated to a temperature (e.g., about 150° C. to about 200° C.) or subject to a reaction that substantially vaporizes, melts, or deflagrates the sacrificial material 240 but does not substantially degrade the polymeric housing 125 and optionally, the reinforcing fibers. Any suitable solvent, such as, but not limited to acetone, may be applied to the materials to dissolve them, optionally with agitation, so long as the solvent does not substantially degrade or dissolve the polymeric composite housing and optionally, the reinforcing fibers. Alternatively, the sacrificial material 240 may be etched using a suitable acid (e.g., hydrochloric acid, sulfuric acid, nitric acid, and the like). Although not shown, it is contemplated herein, that the methods described herein also include providing access to the channel precursor material 230, for example, by drilling into (not shown) the polymeric housing 125 so that the removal step may be performed on the sacrificial material 240. The degradants may be removed to form channels 180 defined in one or more of: (i) the polymeric housing 125; (ii) the exhaust liner 115; (iii) the head framework 105; and (iv) the intake liner 120, for example, by applying a vacuum to the aforementioned components or introducing a gas to the aforementioned components to expel the degradants out of the aforementioned components. In any embodiment, the channels 180 defined in one or more of: the head framework 105, the exhaust liner 115, the intake liner 120, and the polymeric housing 125 may be interconnected with one another including fluidly interconnected and/or physically interconnected. In some embodiments, where the channel precursor material 230a includes an outer shell 192, the outer shell 192 remains after the degradants have been removed.

Additionally or alternatively, the method may comprise further steps for assembling a cylinder head assembly. For example, following removal of the sacrificial material 230, a cylinder head assembly can be assembled by removing the intake port form 122 and the exhaust port form 117, defining a combustion device region 130 in the polymeric housing 125, and providing and assembling a combustion device (not shown), an intake valve (not shown), and an exhaust valve (not shown). It also contemplated herein that a cylinder head assembly may include any further coolant channels, for example, defined the head framework, as understood in the art.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cylinder head assembly for an engine comprising:
a metal head framework defining a portion of: a combustion chamber, an intake valve guide, and an exhaust valve guide;
an exhaust liner defining an exhaust port, wherein the exhaust liner comprises a thermal barrier material comprising an insulating layer, and wherein at least a portion of the exhaust liner is disposed adjacent to at least a portion of the metal head framework;
an intake liner defining an intake port, wherein the intake liner comprises a material selected from the group consisting of a metal material, a polymeric material, the thermal barrier material, and combinations thereof;
a polymeric housing disposed around at least a portion of the metal head framework and the exhaust liner; and
a plurality of channels defined in one or more of:
(i) the metal head framework;
(ii) the exhaust liner; and
(iii) the polymeric housing.

2. The cylinder head assembly of claim 1, wherein the polymer in the polymeric housing and the polymeric material each comprise a thermoplastic polymer or a thermoset polymer.

3. The cylinder head assembly of claim 1, wherein the polymeric housing and the polymeric material each further comprise a plurality of reinforcing fibers, wherein the plurality of reinforcing fibers are selected from the group consisting of carbon fibers, glass fibers, aramid fibers, polyethylene fibers, organic fibers, metallic fibers, and combinations thereof.

4. The cylinder head assembly of claim 1, wherein the plurality of channels each has a diameter of about 100 μm to about 10 mm.

5. The cylinder head assembly of claim 1, wherein the plurality of channels comprise an outer shell having a wall thickness of about 1 μm to about 1 mm, wherein the outer shell comprises a metal, a polymer, a polymeric composite, or a combination thereof.

6. The cylinder head assembly of claim 1, wherein the plurality of channels defined in the metal head framework, the exhaust liner, and the polymeric housing are interconnected with one another.

7. The cylinder head assembly of claim 1, wherein at least a portion of the plurality of channels extend circumferentially around a first exterior surface of the exhaust liner or at least a portion of the plurality of channels extend longitudinally along the first exterior surface of the exhaust liner.

8. The cylinder head assembly of claim 1, wherein the insulating layer further comprises a plurality of microspheres comprising at least one of a metal alloy, polymer, glass, and ceramic, wherein the plurality of microspheres each has a diameter of about 10 μm to 100 μm; and wherein the insulating layer has a porosity of at least about 50%.

9. The cylinder head assembly of claim 1, wherein the thermal barrier material further comprises a sealing material.

10. A method of manufacturing a cylinder head assembly for an engine comprising:
(a) a thermal barrier formation step comprising one or more of the following:
(i) applying an insulating layer precursor to a second exterior surface of an exhaust port form and solidifying the insulating layer precursor applied to the second exterior surface of the exhaust port form to form an exhaust liner comprising a thermal barrier material;
(ii) applying the insulating layer precursor to a third exterior surface of an intake port form and solidifying the insulating layer precursor applied to the third exterior surface of the intake port form to form an intake liner comprising the thermal barrier material; and
(iii) performing a casting, molding, or three-dimensional (3D) printing process to form the exhaust liner defining an exhaust port and/or the intake liner defining an intake port and providing a packing material to the exhaust port and/or the intake port;
(b) a casting step comprising one or more of the following:
(i) arranging the exhaust liner in a first mold and casting a metal head framework defining a portion of a combustion chamber; and
(ii) arranging the intake liner in the first mold and casting the metal head framework;
(c) a channel formation step for forming an intermediate assembly comprising applying a channel precursor material comprising a sacrificial material to the exhaust liner, the metal head framework, or a combination thereof; and
(d) a polymeric formation step comprising:
placing the intermediate assembly in a second mold;
introducing a polymer precursor into the second mold;
solidifying the polymer precursor to form a solid polymeric assembly comprising a polymeric housing disposed around one or more of: at least a portion of the metal head framework, at least a portion of the exhaust liner; and
at least a portion of the intake liner; and
if present, removing the sacrificial material to form a plurality of channels defined in one or more of:
(i) the metal head framework
(ii) the polymeric housing; and
(iii) the exhaust liner.

11. The method of claim 10, wherein the polymer comprises a thermoplastic polymer or a thermoset polymer.

12. The method of claim 10, wherein applying the channel precursor material comprises one or more of:
(i) applying the channel precursor material circumferentially around at least a portion of a first exterior surface of the exhaust liner;
(ii) applying the channel precursor material within a void region between microspheres in the exhaust liner; and
(iii) applying the channel precursor material longitudinally along at least a portion of the first exterior surface of the exhaust liner.

13. The method of claim 10, wherein the sacrificial material comprises a material capable of one or more of: melting, vaporizing, combusting, and solubilizing.

14. The method of claim 10, wherein the channel precursor material further comprises an outer shell containing the sacrificial material, wherein outer shell comprises a metal, a polymer, a polymeric composite, a ceramic, or a combination thereof, wherein the sacrificial material comprises a material capable of one or more of: melting, vaporizing, combusting, and solubilizing, and wherein the shell remains after the sacrificial material is removed.

15. The method of claim 10, wherein the insulating layer comprises a low conductivity material and/or the insulating layer further comprises a plurality of microspheres comprising at least one of a metal alloy, polymer, glass and ceramic; and
wherein the thermal barrier formation step further comprises one or more of:
(i) adhering the respective plurality of microspheres applied to the second exterior surface of the exhaust port form together to form the exhaust liner and
(ii) adhering the respective plurality of microspheres applied to the third exterior surface of the intake port form together to form the intake liner.

16. The method of claim 15, wherein the thermal barrier formation step further comprises one or more of:
(i) applying a sealing material to the second exterior surface of the exhaust port form;
(ii) applying the sealing material to the third exterior surface of the intake port form;
(iii) applying the sealing material to a fourth exterior surface of the insulating layer precursor; and
(iv) applying the sealing material to a fifth exterior surface of the thermal barrier material.

17. The method of claim 10, wherein the casting step further comprises arranging an intake liner port form in the first mold and the metal head framework further defines a portion of an intake liner.

18. The method of claim 10, wherein the polymeric housing further defines a portion of an intake liner.

19. The method of claim 15, wherein the insulating layer has a porosity of at least about 50% and the plurality of microspheres each has a diameter of about 10 μm to 100 μm.

20. The method of claim 10, wherein the plurality of channels defined in the metal head framework, the exhaust liner, and the polymeric housing are interconnected with one another.
